(19) United States
(12) Patent Application Publication
(10) Pub. No.: US 2026/0267262 A1
(43) Pub. Date: Sep. 10, 2026

(54) IMAGE FORMING APPARATUS AND METHOD FOR FIXING TONER IMAGE TO RECORDING MATERIAL

(71) Applicant: CANON KABUSHIKI KAISHA, Tokyo (JP)

(72) Inventors: AKIHIRO MAEDA, Tokyo (JP); SHIGEAKI TAKADA, Chiba (JP); RYO YASHIRO, Tokyo (JP); RYOSUKE HATTORI, Chiba (JP)

(21) Appl. No.: 19/554,371

(22) Filed: Mar. 2, 2026

(30) Foreign Application Priority Data
Mar. 5, 2025 (JP) 2025-034609

(51) Int. Cl. G03G 15/20; B08B 1/20; B08B 1/30; G03G 15/00

(52) U.S. Cl. CPC G03G 15/2053; B08B 1/20; B08B 1/30; G03G 15/2039; G03G 15/2064; G03G 15/50; G03G 15/70; G03G 2215/2038

(57) ABSTRACT

An image forming apparatus including a fixing device configured to fix a toner image formed on a recording material to the recording material, the image forming apparatus includes an endless rotatable belt, a pressure rotary member, a nip portion forming member, an internal heating roller, an external heating roller, a first detection unit, a second detection unit, a first cleaning unit configured to clean the outer peripheral surface of the belt, and a control unit configured to execute a cleaning mode in which toner adhering to the outer peripheral surface of the belt is removed after a jam. The control unit is configured to rotate the belt and cause the first cleaning unit to clean the outer peripheral surface of the belt in a state in which the temperature of the external heating roller is higher than the temperature of the internal heating roller in the cleaning mode.

### BACKGROUND

### Field of the Technology

The present disclosure relates to an image forming apparatus such as a printer, a copier, a facsimile machine, or a multifunction peripheral, and a method for fixing a toner image to a recording material.

### Description of the Related Art

An image forming apparatus includes a fixing device that fixes a toner image on a recording material by applying heat and pressure to the recording material while nipping and conveying the recording material on which the toner image is formed. Examples of the fixing device include a fixing device including an endless fixing belt, a fixing roller that is in contact with an inner peripheral surface of the fixing belt, and a pressure roller that pressurizes the fixing belt with the fixing roller in order to form a fixing nip portion that fixes the toner image (See, J P 2008-170649 A). In addition, the fixing device includes an internal heating roller that is in contact with the inner peripheral surface of the fixing belt and heats the fixing belt, an external heating roller that is in contact with an outer peripheral surface of the fixing belt and heats the fixing belt, and a nonwoven fabric (hereinafter, referred to as a web) for removing toner adhering to the external heating roller mainly via the fixing belt.

As discussed in JP 2008-170649 A, in order to remove the toner adhering to the fixing belt by using the web, control is performed for idle rotation in a state in which a temperature of the fixing belt is higher than a temperature of the external heating roller. That is, since the toner easily moves (migrates) from a higher-temperature region to a lower-temperature region, the temperatures of the external heating roller and the internal heating roller are adjusted so as to move the toner from the fixing belt having a higher temperature to the external heating roller having a lower temperature, so that the web cleans the external heating roller.

As another example of the fixing device, JP 2017-32772 A discusses a fixing device including a fixing roller including a heater therein, a pressure roller that pressurizes the fixing roller to form a fixing nip portion, and an external heating belt that is in contact with an outer peripheral surface of the fixing roller and heats the fixing roller. The fixing device includes two cleaning units including a cleaning unit that includes a web for cleaning toner adhering to the fixing roller and a cleaning unit that includes a cleaning roller for cleaning toner adhering to the external heating belt.

### SUMMARY

An aspect of the present disclosure provides an image forming apparatus including a fixing device configured to fix a toner image to a recording material, the image forming apparatus includes a belt; a rotary member configured to pressurize the belt from an outer side of the belt; a nip portion forming member disposed on an inner side of the belt, configured to sandwich the belt with the rotary member; an internal heating roller disposed on the inner side of the belt and configured to heat the belt; an external heating roller in contact with an outer peripheral surface of the belt and configured to heat the belt; a first detection unit configured to detect a temperature of the internal heating roller; a second detection unit configured to detect a temperature of the external heating roller; a first cleaning unit configured to clean the outer peripheral surface of the belt; a second cleaning unit configured to clean an outer peripheral surface of the external heating roller by a method different from a method used by the first cleaning unit; and a control unit configured to execute a cleaning mode in which toner adhering to the outer peripheral surface of the belt is removed after a jam of the recording material. In the cleaning mode, the control unit is configured to rotate the belt and cause the first cleaning unit to clean the outer peripheral surface of the belt in a state in which the temperature of the external heating roller is higher than the temperature of the internal heating roller.

Another aspect of the present disclosure provides an image forming apparatus including a fixing device configured to fix a toner image to a recording material, the image forming apparatus includes a belt; a rotary member configured to pressurize the belt from an outer side of the belt; a nip portion forming member disposed on an inner side of the belt, configured to sandwich the belt with the rotary member; an internal heating roller disposed on the inner side of the belt and configured to heat the belt; an external heating roller configured to contact with an outer peripheral surface of the belt and heat the belt; a first detection unit configured to detect a temperature of the internal heating roller; a second detection unit configured to detect a temperature of the external heating roller; a first cleaning unit configured to clean the outer peripheral surface of the belt; a second cleaning unit configured to clean an outer peripheral surface of the external heating roller by a method different from a method used by the first cleaning unit; and a control unit configured to execute a cleaning mode in which toner adhering to the outer peripheral surface of the belt is removed after a jam of the recording material. In the cleaning mode, the control unit is configured to separate the second cleaning unit from the external heating roller, cause the first cleaning unit to clean the outer peripheral surface of the belt in a state in which the temperature of the external heating roller is higher than the temperature of the internal heating roller, and bring the second cleaning unit into contact with the external heating roller.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic view illustrating an image forming apparatus of the present embodiment.

FIG. 2 is a schematic view illustrating a fixing device.

FIG. 3 is a schematic view illustrating a part of the fixing device when viewed from a longitudinal direction.

FIG. 4 is a schematic view illustrating a part of the fixing device when viewed from a downstream side in a conveyance direction.

FIG. 5A is a schematic view illustrating a separated state of a belt cleaning unit.

FIG. 5B is a schematic view illustrating a contact state of the belt cleaning unit.

FIG. 6A is a schematic view illustrating a separated state of a roller cleaning unit.

FIG. 6B is a schematic view illustrating a contact state of the roller cleaning unit.

FIG. 7 is a control block diagram illustrating a control system that performs cleaning control for residual toner by using the belt cleaning unit and the roller cleaning unit.

FIG. 8 is a flowchart illustrating a cleaning control processing at the time of image formation.

FIG. 9 is a flowchart illustrating the cleaning control processing executed in a case where a temperature of an internal heating roller is within a predetermined range during jam processing.

FIG. 10 is a graph illustrating an amount of toner adhering to a member having a lower temperature depending on a temperature difference between members.

FIG. 11 is a flowchart illustrating the cleaning control processing executed in a case where the temperature of the internal heating roller is lower than the predetermined range during the jam processing.

FIG. 12 is a flowchart illustrating the cleaning control processing executed in a case where the temperature of the internal heating roller is higher than the predetermined range during the jam processing.

### DESCRIPTION OF THE EMBODIMENTS

### Image Forming Apparatus

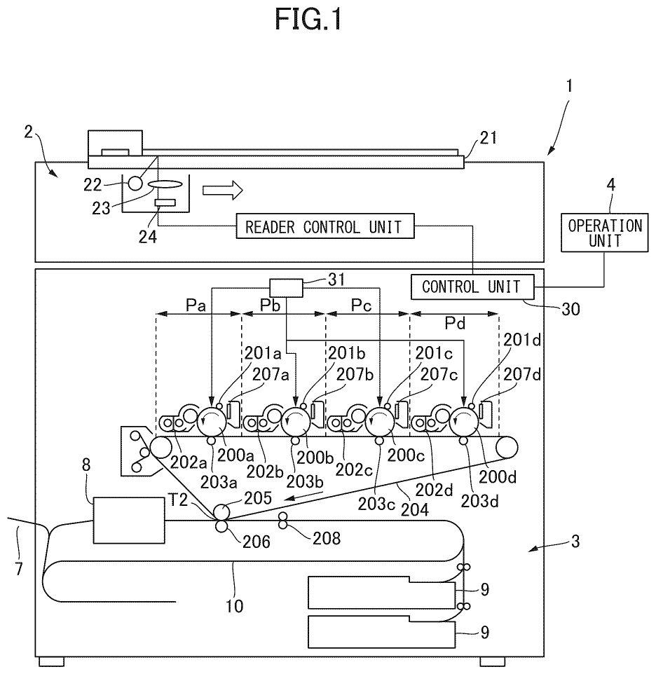

A configuration of an image forming apparatus of the present embodiment will be described with reference to FIG. 1. An image forming apparatus 1 is an electrophotographic full-color printer including four image forming units Pa, Pb, Pc, and Pd provided corresponding to four colors of yellow, magenta, cyan, and black. The present embodiment is the tandem-type image forming apparatus 1 in which the image forming units Pa, Pb, Pc, and Pd are arranged in a rotation direction of an intermediate transfer belt 204. The image forming apparatus 1 forms a toner image (image) on a recording material according to an image signal from a document reading apparatus 2 connected to an apparatus body 3 of the image forming apparatus 1 or external device such as a computer communicably connected to the apparatus body 3. Examples of the recording material include sheet materials such as paper, a plastic film, and cloth.

As illustrated in FIG. 1, the image forming apparatus 1 includes the document reading apparatus 2 and the apparatus body 3. The document reading apparatus 2 reads a document placed on a platen glass 21, and light emitted from a light source 22 is reflected by the document and forms an image on a charge-coupled device (CCD) sensor 24 via an optical system member 23 such as a lens. Such optical system unit reads the document line by line and converts the document into an electric signal data string when scanning is performed in a direction of an arrow under the control of a reader control unit. An image signal obtained by the CCD sensor 24 is sent to the apparatus body 3, and a control unit 30 executes image processing according to each image forming unit, described below. The control unit 30 also receives an external input such as an image signal from an external host device such as a print server.

The apparatus body 3 includes a plurality of image forming units Pa, Pb, Pc, and Pd, and each image forming unit performs image formation based on the above-described image signal. That is, the image signal is converted into a laser beam subjected to pulse width modulation (PWM) by the control unit 30. A polygon scanner 31 serving as an exposure device performs scanning with the laser beam according to the image signal. Then, photosensitive drums 200a, 200b, 200c, and 200d of the respective image forming units Pa to Pd are irradiated with the laser beam.

The image forming unit Pa forms a yellow (Y) toner image, the image forming unit Pb forms a magenta (M) toner image, the image forming unit Pc forms a cyan (C) toner image, and the image forming unit Pd forms a black (Bk) toner image. The image forming units Pa to Pd have substantially the same configuration. The image forming unit Pa that forms the yellow (Y) toner image is described below as an example, and description of the other image forming units Pb to Pd is incorporated by reference, for conciseness. The image forming unit Pa forms the toner image on a surface of the photosensitive drum 200a based on the image signal.

A charging roller 201a charges the surface of the photosensitive drum 200a to a predetermined potential to prepare for forming an electrostatic latent image. The electrostatic latent image is formed on the surface of the photosensitive drum 200a charged to the predetermined potential by the laser beam from the polygon scanner 31. A developer 202a develops the electrostatic latent image on the photosensitive drum 200a into the toner image by using a developer containing the toner. The toner contains wax in order to improve release performance from a fixing device 8 described below, fixability of the toner, and the like at the time of fixing the toner image on the recording material. The toner includes colored resin particles containing a binder resin, a colorant, and other additives as necessary, and colored particles externally blended with an external additive such as colloidal silica fine powder. As the wax, for example, polyolefin wax, long-chain hydrocarbon-based wax, dialkyl ketone-based wax, ester-based wax, or amide-based wax is used. A wax content in the toner is 3% to 30%, by mass.

A primary transfer roller 203a performs discharging from the inside of the intermediate transfer belt 204, applies a primary transfer bias having a polarity opposite to that of the toner, and transfers the toner image on the photosensitive drum 200a onto the intermediate transfer belt 204. The surface of the photosensitive drum 200a after the transfer is cleaned by a cleaner 207a.

Furthermore, the toner image on the intermediate transfer belt 204 is conveyed to the next image forming unit, the toner images of the respective colors formed by the respective image forming units Pa to Pd are sequentially transferred in the order of yellow (Y), magenta (M), cyan (C), and black (Bk), and an image of four colors is formed on a surface of the intermediate transfer belt 204. Then, the toner image that has passed through the image forming unit Pd positioned most downstream in the rotation direction of the intermediate transfer belt 204 is conveyed to a secondary transfer portion T2 formed by a pair of secondary transfer rollers 205 and 206. Then, a secondary transfer electric field having a polarity opposite to that of the toner image on the intermediate transfer belt 204 is applied at the secondary transfer portion T2, whereby the toner image is secondarily transferred from the intermediate transfer belt 204 to the recording material.

The recording material is accommodated in a cassette 9, and the recording material fed from the cassette 9 is conveyed to, for example, a registration portion 208 formed by a pair of registration rollers, and waits at the registration portion 208. Thereafter, timing control for the registration portion 208 is performed to align the toner image on the intermediate transfer belt 204 and paper, and the recording material is conveyed to the secondary transfer portion T2.

The recording material to which the toner image has been transferred at the secondary transfer portion T2 is conveyed to the fixing device 8, and the toner image is fixed to the recording material by heat and pressure applied by the fixing device 8. The recording material that has passed through the fixing device 8 is discharged to a discharge tray 7. In a case where image formation is performed on both sides of the recording material, once the transfer and fixing of the toner image onto a first side (front side) of the recording material are completed, the recording material is inverted via a reverse conveyance unit 10, the transfer and fixing of the toner image onto a second side (back side) of the recording material is performed, and then the recording material is discharged to the discharge tray 7.

The control unit 30 performs overall control of the image forming apparatus 1 described above. The control unit 30 can perform various settings and the like based on an input from an operation unit 4 included in the image forming apparatus 1. The operation unit 4 may be, for example, a touch panel including a display unit, and receives inputs for starting various programs such as an image forming job, various data inputs, and the like according to a touch operation from a user. The control unit 30 includes a central processing unit (CPU), a read only memory (ROM), and a random access memory (RAM).

The ROM and the RAM store, for example, various programs such as the image forming job for forming an image on the recording material, and various data such as image data. In response to the CPU executing the image forming job (program) stored in the ROM, the image forming apparatus 1 performs an image forming operation of forming an image on the recording material. The RAM temporarily stores calculation processing results and the like accompanying the execution of various programs. The inputs for starting various programs, such as the image forming job and various data inputs, are not limited to being received through the operation unit 4, and may be received from, for example, an external device communicably connected to the image forming apparatus 1.

The image forming job is a series of operations from the start of image formation to the completion of the image forming operation based on the image signal for forming an image on the recording material. That is, the image forming job is a series of operations from the start of a preliminary operation (i.e., pre-rotation) necessary for performing image formation, proceeding through an image forming process, to the completion of a preliminary operation (i.e., post-rotation) necessary for ending the image formation.

### Fixing Device

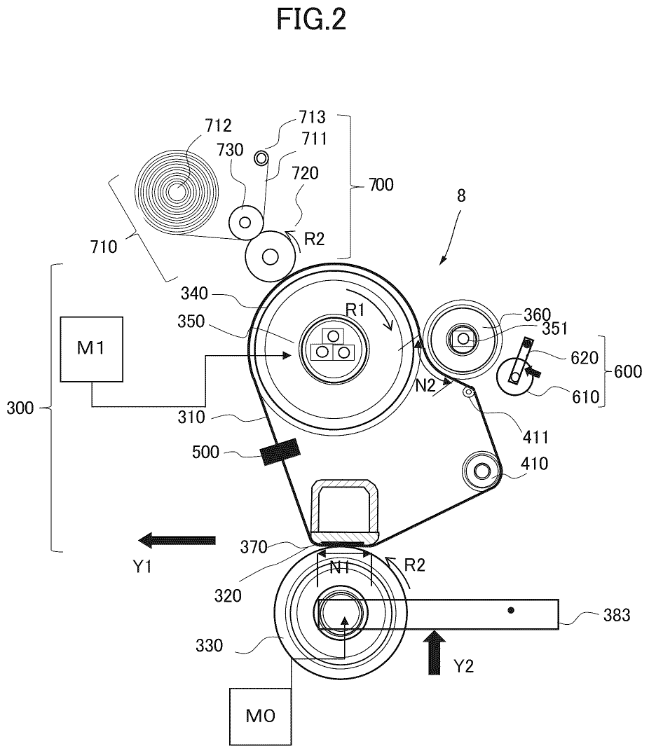

The fixing device 8 of the present embodiment will be described with reference to FIGS. 2 to 4. In the present embodiment, the belt-heating type fixing device 8 using an endless fixing belt 310 is adopted. In FIG. 2, the recording material on which the toner image is formed is conveyed from right to left (Y1). As illustrated in FIG. 2, the fixing device 8 includes a heating unit 300, a pressure roller 330 serving as a pressure rotary member, a belt cleaning unit 700, and a roller cleaning unit 600.

### Pressure Roller

The pressure roller 330 includes an elastic layer formed on an outer periphery of a rotation shaft and a release layer formed on an outer periphery of the elastic layer. The rotation shaft is made of stainless steel, the elastic layer is made of conductive silicon rubber to have a thickness of 5 mm, and the release layer is made of tetrafluoroethylene-perfluoroalkoxyethylene copolymer resin (PFA) to have a thickness of 50 μm. The pressure roller 330 is rotatably supported by a fixing frame 380 of the fixing device 8, is connected to a drive motor M0 via a gear fixed to one end portion in a rotation axis direction, and is rotationally driven by the drive motor M0.

The pressure roller 330 is disposed to sandwich the fixing belt 310 with a pad 320, and a pressure frame 383 moves in a direction of arrow Y2 by a drive source and a cam to pressurize the fixing belt 310 with the pad 320. As a result, a fixing nip portion N1 is formed between the fixing belt 310 and the pressure roller 330. The recording material bearing the toner image is nipped and conveyed at the fixing nip portion N1, and at this time, the heat and pressure are applied to fix the toner image onto the recording material. As an example, at the time of image formation, a rotational speed of the fixing belt 310 is 630 mm/s, a pressurizing force of the pressure roller 330 is 1000 N, and a target temperature of the fixing belt 310 is about 180° C. to 215° C.

### Heating Unit

The heating unit 300 includes the endless fixing belt 310, the pad 320 serving as a nip portion forming member, a stay 382, an internal heating roller 340, an inner roller 411, a steering roller 410, and an external heating roller 360. The fixing belt 310 is rotatably tensioned by the pad 320, the internal heating roller 340, the inner roller 411, and the steering roller 410, which are disposed on an inner side of the fixing belt 310, and is pressurized by the pressure roller 330 disposed on an outer side of the fixing belt 310.

The fixing belt 310 has thermal conductivity, heat resistance, and the like, and is formed in a thin cylindrical shape having an inner diameter of 160 mm, for example. The fixing belt 310 includes a base layer, an elastic layer positioned on an outer periphery of the base layer, and a release layer positioned on an outer periphery of the elastic layer. For example, the base layer is made of a polyimide resin (PI) to have a thickness of 60 μm, the elastic layer is made of silicon rubber to have a thickness of 300 μm, and the release layer is made of PFA to have a thickness of 30 μm.

The pad 320 is held by the stay 382 and pressurized by the pressure roller 330 disposed to sandwich the fixing belt 310 with the pad 320. The stay 382 that holds the pad 320 is made of metal such as stainless steel or iron, and has a substantially rectangular cross section (lateral cross section) orthogonal to a longitudinal direction intersecting a rotation direction of the fixing belt 310. The pad 320 is formed using, for example, a liquid crystal polymer (LCP) resin. A lubricating member 370 is disposed between the pad 320 and the fixing belt 310. The lubricating member 370 is, for example, a polyimide (PI) sheet made of PI coated with polytetrafluoroethylene (PTFE) and formed to have a thickness of 100 μm. A large number of protrusions having a height of 100 μm may be formed at intervals of 1 mm on the PI sheet in order to reduce a contact range with the fixing belt 310 and reduce a sliding resistance.

In addition, a lubricant applied to an inner peripheral surface of the fixing belt 310 enables smooth sliding with respect to the pad 320 when the fixing belt 310 rotates, together with the lubricating member 370. As the lubricant, for example, silicone oil having a viscosity of 100 cSt is used. Although the pad 320 is used to form the fixing nip portion N1 that fixes the toner image onto the recording material, the present technology is not limited thereto, and a rotary member such as a roller may be used instead of the pad 320.

### Internal Heating Roller

The internal heating roller 340 is disposed on the inner side of the fixing belt 310, and tensions the fixing belt 310 together with the pad 320, the steering roller 410, and the inner roller 411. Since the lubricant is applied to the inner peripheral surface of the fixing belt 310 as described above, the internal heating roller 340 tensions at least the fixing belt 310 via the lubricant. The internal heating roller 340 is formed in a cylindrical shape and made of metal such as aluminum or stainless steel. From the viewpoint of thermal conductivity, the internal heating roller 340 is formed of, for example, an aluminum pipe having an outer diameter of 80 mm and a thickness of 1 mm.

A halogen heater 350 for heating the internal heating roller 340 is disposed inside the internal heating roller 340. The number of halogen heaters 350 may be one. However, the number of halogen heaters 350 may be plural in view of temperature distribution control of the internal heating roller 340 in the longitudinal direction (rotation axis direction). In the present embodiment, the fixing belt 310 is heated by the internal heating roller 340 and the external heating roller 360 described below. The internal heating roller 340 may be heated not only by using the halogen heater 350, but also by using another heater such as a carbon heater. Alternatively, an electromagnetic induction heating device may include an excitation coil that is provided on an outer side of the internal heating roller 340 and generates a magnetic field by current application to inductively heat the internal heating roller 340, and a magnetic core that covers the excitation coil.

A gear is fixed to one end portion of the internal heating roller 340 in the longitudinal direction (rotation axis direction), and the internal heating roller 340 is connected to a drive motor M1 via the gear. When the internal heating roller 340 is rotationally driven by the drive motor M1, a driving force is applied to the fixing belt 310, and the fixing belt 310 rotates. Here, the force applied from the internal heating roller 340 to the fixing belt 310 is an auxiliary driving force. Drive transmission from the drive motor M1 may be performed through, for example, a mechanism using a pulley and a belt, a mechanism pressing a roller driven by the drive motor M1 from the outside, or the like other than the gear. The internal heating roller 340 may be rotationally driven by the drive motor M0 that drives the pressure roller 330 described above.

### Steering Roller

The steering roller 410 tensions the fixing belt 310 together with the pad 320, the internal heating roller 340, and the inner roller 411, and rotates following the fixing belt 310. The steering roller 410 tensions the fixing belt 310 at a position downstream of the inner roller 411 and upstream of the pad 320 in the rotation direction of the fixing belt 310. The steering roller 410 is formed in a cylindrical shape and made of metal such as aluminum or stainless steel. The steering roller 410 is, for example, a stainless steel cylindrical member having an outer diameter of 40 mm and a thickness of 1 mm, and both end portions of the steering roller 410 in the longitudinal direction are rotatably supported by bearings.

The steering roller 410 is provided so as to be swingable with respect to the rotation axis direction (longitudinal direction) of the internal heating roller 340. When the steering roller 410 swings with respect to the internal heating roller 340, the fixing belt 310 reciprocates in the longitudinal direction. The steering roller 410 includes a pivot shaft at the center in the longitudinal direction, and swings around the pivot shaft as a pivoting center. When the steering roller 410 swings, a tension difference occurs in the fixing belt 310 between one end portion and the other end portion of the fixing belt 310 in the longitudinal direction, so that the fixing belt 310 reciprocates in the longitudinal direction. By causing the fixing belt 310 to reciprocate in this manner, the rotating fixing belt 310 is prevented from excessively approaching the end portion of the internal heating roller 340 in the longitudinal direction (i.e., belt deviation control).

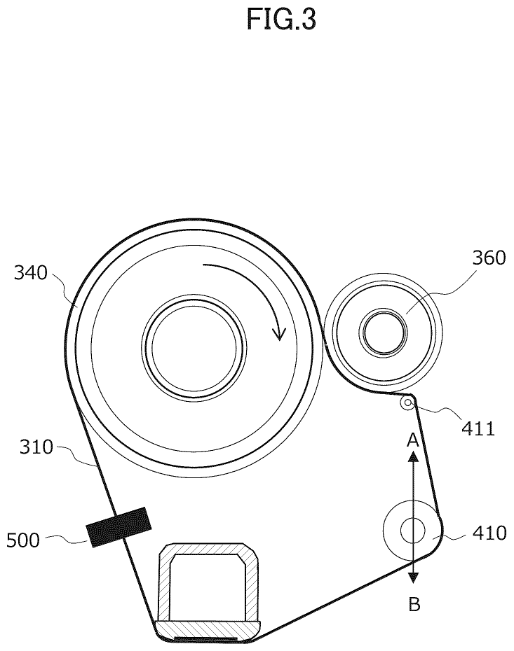

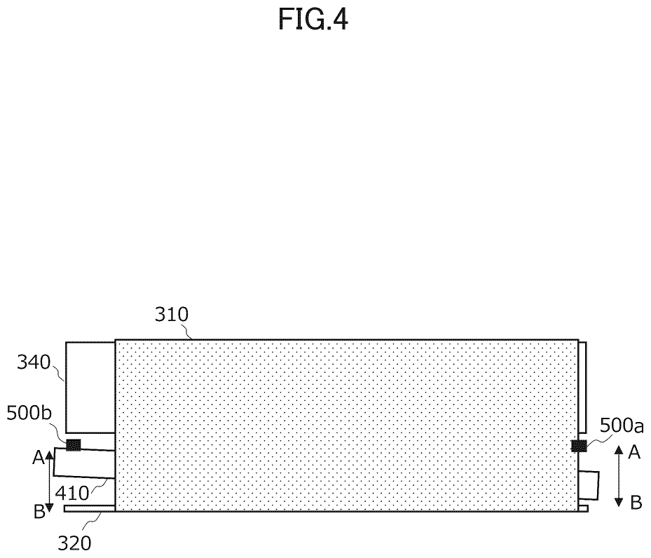

An operation of the steering roller 410 will be described with reference to FIGS. 3 and 4. As illustrated in FIG. 3, for example, in a case where one end side (front side) of the steering roller 410 in the longitudinal direction moves upward (a direction of arrow A), the other end side (back side) of the steering roller 410 in the longitudinal direction moves downward (a direction of arrow B). As a result, the fixing belt 310 moves from the back side to the front side. On the other hand, in a case where the front side of the steering roller 410 moves downward (the direction of arrow B), the back side of the steering roller 410 moves upward (the direction of arrow A). As a result, the fixing belt 310 moves from the front side to the back side. The directions in which both ends (front side and back side) of the steering roller 410 move are not limited to the above-described vertical direction (the directions of arrows A and B).

As illustrated in FIG. 4, photosensors 500a and 500b are disposed on both end sides of the fixing belt 310 in the longitudinal direction in order to detect a position of the fixing belt 310 in the longitudinal direction. The photosensors 500a and 500b are transmissive photosensors each including a light emitting element and a light receiving element disposed opposite to each other. With each of the photosensors 500a and 500b, the presence or absence of the fixing belt 310 is detected by the control unit 30 (see FIG. 1) based on whether the light receiving element has received light emitted from the light emitting element. When the fixing belt 310 enters between the light emitting element and the light receiving element, the light emitted from the light emitting element is blocked by the fixing belt 310 and is not received by the light receiving element. Thus, the control unit 30 can detect that the fixing belt 310 is at a position corresponding to any one of the photosensors 500a and 500b.

For example, with the fixing belt 310 moved from the back side to the front side, one end portion of the fixing belt 310 reaches the photosensor 500a. In this case, the control unit 30 detects that the fixing belt 310 is present on a side of the photosensor 500a, and it is thus determined that the fixing belt 310 is positioned close to the front side. Thus, the control unit 30 performs control to move the front side of the steering roller 410 upward (the direction of arrow A) in order to move the fixing belt 310 from the front side to the back side. With the fixing belt 310 moved from the front side to the back side, the other end portion of the fixing belt 310 reaches the photosensor 500b. In this case, the control unit 30 detects that the fixing belt 310 is present on a side of the photosensor 500b, and it is thus determined that the fixing belt 310 is positioned close to the back side. Thus, the control unit 30 performs control to move the front side of the steering roller 410 downward (the direction of arrow B) in order to move the fixing belt 310 from the back side to the front side. In this way, the steering roller 410 repeats an operation like a seesaw, so that the fixing belt 310 reciprocates in the longitudinal direction. The position of the fixing belt 310 in the longitudinal direction may be detected not only by using the photosensors 500a and 500b, but also by using a flag sensor, a CCD line sensor, or the like.

A steering function of positioning the fixing belt 310 in the longitudinal direction within a predetermined range is implemented by switching the movement of the steering roller 410 according to the position of the fixing belt 310 reciprocating in the longitudinal direction. The steering roller 410 may be configured to swing by a drive source such as a motor, or may be configured to swing by automatic alignment. The pivoting center of the steering roller 410 may be the center in the longitudinal direction as in the present embodiment, or may be the end portion in the longitudinal direction.

In the present embodiment, the steering roller 410 is also a tension roller that applies a predetermined tension to the fixing belt 310 by biasing the fixing belt 310 from the inner side toward the outer side by a spring supported by the fixing frame 380. The tension applied by the spring is, for example, 40 N. As the steering roller 410 applies the tension to the fixing belt 310, the fixing belt 310 follows the pad 320.

A tensioning member disposed at a position of the steering roller 410 is not limited to the steering roller 410 having the steering function, and may be a roller that does not have the steering function. For example, the stretching member may be a tension roller that applies the tension to the fixing belt 310 or a roller that moves so as to change a track of the fixing belt 310 depending on a type of the recording material. Alternatively, the tensioning member may tension the fixing belt 310.

### Inner Roller

Returning to FIG. 2, in order to maintain a posture of the fixing belt 310 in a circumferential direction, the inner roller 411 is in contact with the inner peripheral surface of the fixing belt 310 at a position downstream of the external heating roller 360 in the rotation direction of the fixing belt 310. The inner roller 411 is disposed so as to push the fixing belt 310 toward the external heating roller 360. That is, the inner roller 411 causes the fixing belt 310 to project from the inner side toward the outer side, which is opposite to the external heating roller 360 described below.

The inner roller 411 increases a contact area between the fixing belt 310 and the external heating roller 360, thereby improving efficiency in heating the fixing belt 310 by the external heating roller 360. In addition, since the inner roller 411 is provided, even if the steering roller 410 swings, the contact area between the fixing belt 310 and the external heating roller 360 can be maintained constant in the longitudinal direction. The inner roller 411 is formed in a cylindrical shape and is made of metal such as aluminum or stainless steel. The inner roller 411 is, for example, a stainless steel roller member having an outer diameter of 6 mm, and both end portions of the inner roller 411 in the longitudinal direction are rotatably supported by bearings.

### External Heating Roller

In the present embodiment, the external heating roller 360 that is in contact with the outer peripheral surface of the fixing belt 310 and heats the fixing belt 310 is provided in order to efficiently increase the temperature of the fixing belt 310 to the target temperature in a short time. The external heating roller 360 is formed in a cylindrical shape and made of metal such as aluminum or stainless steel, and a halogen heater 351 is disposed inside the external heating roller 360. The external heating roller 360 is heated to a predetermined temperature by the halogen heater 351. From the viewpoint of thermal conductivity, the external heating roller 360 is formed of, for example, an aluminum pipe having an outer diameter of 50 mm and a thickness of 1 mm.

The external heating roller 360 is in contact with the fixing belt 310 at a position between the internal heating roller 340 and the steering roller 410 in the rotation direction of the fixing belt 310. The external heating roller 360 is in contact with the outer peripheral surface of the fixing belt 310 at a position downstream of the internal heating roller 340 and upstream of the inner roller 411, and is disposed at a position where the external heating roller 360 pushes the fixing belt 310 from the outer side toward the inner side. As a result, the fixing belt 310 and the external heating roller 360 obtain a contact pressure, and a heating nip portion N2 is formed. The external heating roller 360 rotates following the fixing belt 310. In the present embodiment, the external heating roller 360 is not movable between a position in contact with the fixing belt 310 and a position separated from the fixing belt 310, and is always in contact with the fixing belt 310.

The number of halogen heaters 351 for heating the external heating roller 360 may be one. However, the number of halogen heaters 351 may be plural in view of temperature distribution control of the external heating roller 360 in the longitudinal direction. Further, the external heating roller 360 may be heated not only by using the halogen heater 351, but also by using another heater such as a carbon heater. Alternatively, an electromagnetic induction heating device may include an excitation coil that is provided on an outer side of the external heating roller 360 and generates a magnetic field by current application to inductively heat the external heating roller 360, and a magnetic core that covers the excitation coil.

In the present embodiment, the external heating roller 360 does not sandwich the fixing belt 310 with the internal heating roller 340. The inner roller 411 does not sandwich the fixing belt 310 with the external heating roller 360. That is, the external heating roller 360 is disposed so as not to form a nip portion by sandwiching the fixing belt 310 between the internal heating roller 340 and the external heating roller 360, and the inner roller 411 is disposed so as not to form a nip portion by sandwiching the fixing belt 310 between the external heating roller 360 and the inner roller 411. This is because in a case where the nip portion is formed, when the fixing belt 310 moves in the longitudinal direction along with the swing of the steering roller 410, a resistance may increase and the fixing belt 310 may thus be deformed.

### Belt Cleaning Unit

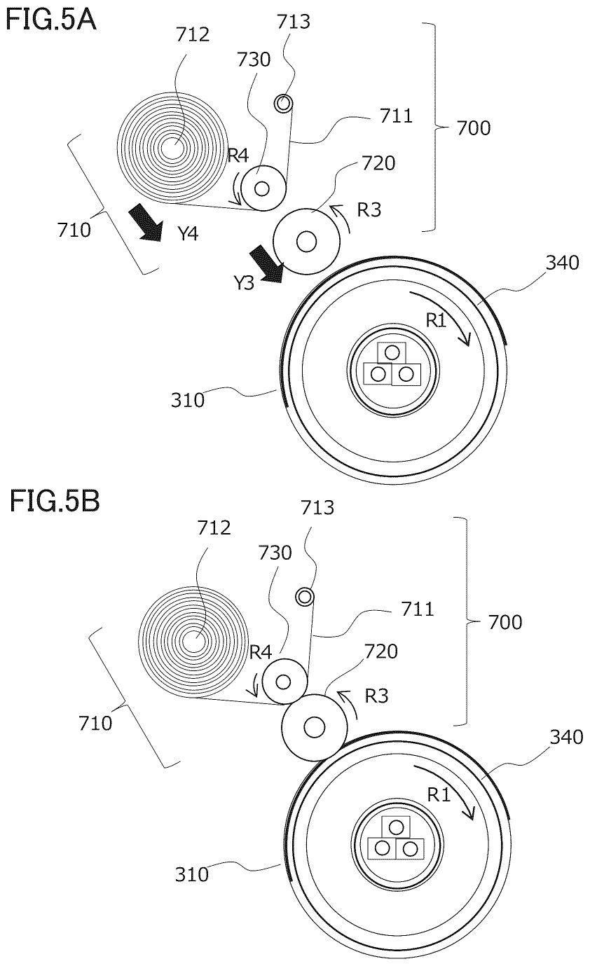

The belt cleaning unit 700 will be described with reference to FIGS. 5A and 5B. The belt cleaning unit 700 is provided to remove the toner and the wax (also referred to as residual toner) remaining attached to the fixing belt 310 after passing through the fixing nip portion N1. The belt cleaning unit 700 serving as a first cleaning unit includes a web unit 710 and a collection roller 720. The web unit 710 includes a web 711, a supply roller 712, a winding roller 713, and a web roller 730.

As illustrated in FIGS. 5A and 5B, the belt cleaning unit 700 is provided so as to be movable between a collection position where the collection roller 720 comes into contact with the fixing belt 310 and collects the residual toner (adhering substance) and a non-collection position where the collection roller 720 is separated from the fixing belt 310 and does not collect the residual toner (adhering substance). In a case where the belt cleaning unit 700 is at the non-collection position, the web unit 710 is provided so as to be movable between a position where the web 711 comes into contact with the collection roller 720 and a position where the web 711 does not come into contact with the collection roller 720, as illustrated in FIG. 5A.

The collection roller 720 is formed in a cylindrical shape and made of metal, e.g. aluminum or stainless steel. In the present embodiment, the collection roller 720 is a stainless steel roller member having an outer diameter of 20 mm. As a drive source and a cam moves the collection roller 720 in a direction of arrow Y3, the collection roller 720 is pressurized against the internal heating roller 340 via the fixing belt 310. The collection roller 720 comes into contact with the internal heating roller 340 via the fixing belt 310 at, for example, 10 N, and rotates in the direction of arrow R3 following the fixing belt 310 rotating in a direction of arrow R1.

The web 711 is, for example, a polyamide nonwoven fabric having a thickness of 50 μm and a length of 40 m, and is wound around the supply roller 712 in a roller shape in advance. When the winding roller 713 is driven by a motor, the web 711 is fed from the supply roller 712 to the winding roller 713 and is wound.

The web roller 730 is, for example, a closed-cell roller having an outer diameter of 24 mm, in which a closed-cell sponge layer having a thickness of 8 mm and made of a silicone rubber foam material is formed on a stainless steel core metal having a diameter of 8 mm. A press mechanism moves web unit 710 in a Y4 direction so as to be able to pressurize the collection roller 720 at, for example, 40 N. As a result, the web 711 is pushed against the collection roller 720 via the web roller 730, and rubs an outer peripheral surface of the collection roller 720 within a contact range of 3 mm.

The residual toner on the fixing belt 310 is melted by heating using the internal heating roller 340 and the external heating roller 360. The collection roller 720 is heated by the internal heating roller 340 via the fixing belt 310, but a temperature of the collection roller 720 is lower than the temperature of the fixing belt 310. Since the residual toner in a molten state moves (migrates) from a higher-temperature region to a lower-temperature region, the residual toner migrates from the fixing belt 310 to the collection roller 720 when the collection roller 720 comes into contact with the fixing belt 310. The collection roller 720 is made of stainless steel having lower release performance than the release layer (PFA) of the fixing belt 310 to allow the residual toner to easily migrate from the fixing belt 310 to the collection roller 720.

The residual toner migrating to the collection roller 720 is removed by the web 711 in the contact range between the web 711 and the collection roller 720. The contact range between the web 711 and the collection roller 720 is incrementally renewed as the web 711 is wound by driving of the winding roller 713, so that a new surface free of toner adhesion is supplied. The web unit 710 may be provided in a replaceable manner so that the web unit 710 can be replaced with a new web unit 710 when the web 711 is used up.

### Roller Cleaning Unit

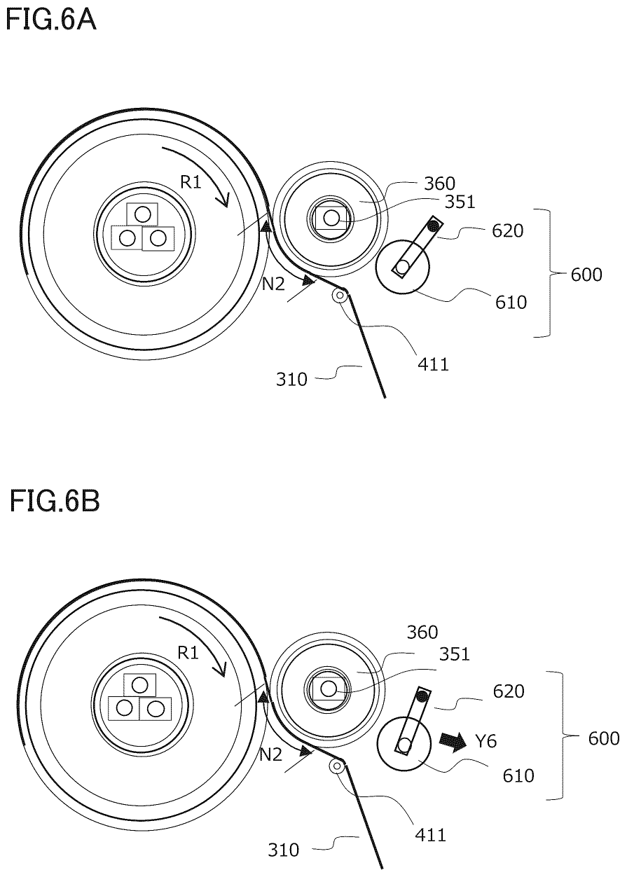

The roller cleaning unit 600 will be described with reference to FIGS. 6A and 6B. The roller cleaning unit 600 is provided to remove the residual toner migrating from the fixing belt 310 to an outer peripheral surface of the external heating roller 360. The roller cleaning unit 600 serving as a second cleaning unit includes a cleaning roller 610 and a holding frame 620 that rotatably holds the cleaning roller 610.

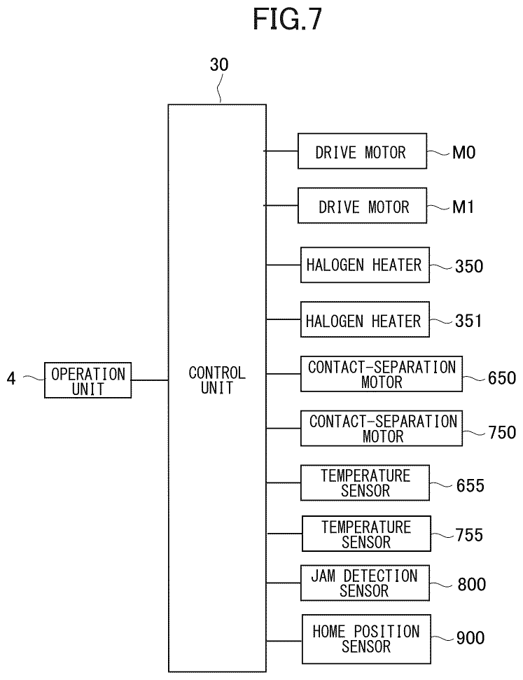

As illustrated in FIGS. 6A and 6B, the roller cleaning unit 600 is provided so as to be movable between a contact position where the cleaning roller 610 comes into contact with the external heating roller 360 and a separated position where the cleaning roller 610 is separated from the external heating roller 360 according to an operation of the holding frame 620. As a contact-separation motor 750 (see FIG. 7, described below) is driven, the holding frame 620 swings such that the cleaning roller 610 is separated from the external heating roller 360 (a direction of arrow Y6). In addition, as the contact-separation motor 750 is driven, the holding frame 620 swings such that the cleaning roller 610 approaches the external heating roller 360. Then, the holding frame 620 pressurizes the cleaning roller 610 against the external heating roller 360 at, for example, 50 N. The cleaning roller 610 can come into contact with the outer peripheral surface of the external heating roller 360 in a state of being pressurized against the external heating roller 360 by the holding frame 620, and remove the residual toner from the external heating roller 360. The cleaning roller 610 rotates following the external heating roller 360.

The cleaning roller 610 is, for example, a closed-cell roller having an outer diameter of 30 mm, in which a closed-cell sponge layer having a thickness of 11 mm and made of a silicone rubber foam material is formed on a surface of a stainless steel rotation shaft having a diameter of 8 mm. Since a surface layer of the cleaning roller 610 is made of the foam material, the residual toner, paper powder, or the like is collected in pores of the closed-cell sponge layer. The silicone rubber foam material contains a conductive filler having conductivity, and the cleaning roller 610 is electrically grounded. When the cleaning roller 610 rubs the external heating roller 360, frictional charging occurs in the external heating roller 360. If the cleaning roller 610 (specifically, the closed-cell sponge layer) is not electrically grounded, a residual toner removal failure occurs due to the frictional charging.

### Control System

A control system that performs cleaning control for the residual toner by using the belt cleaning unit 700 and the roller cleaning unit 600 will be described with reference to FIG. 7, as well as FIG. 2. Various devices may also connect connected to the control unit 30 in addition to those illustrated in the drawings, and for conciseness each of these devices is not illustrated.

As illustrated in FIG. 7, in addition to the operation unit 4, the drive motor M0, the drive motor M1, the halogen heater 350, the halogen heater 351, and temperature sensors 655 and 755 are connected to the control unit 30. The control unit 30 controls the drive motor M0 and the drive motor M1 to start or stop the rotation of the fixing belt 310 via the pressure roller 330 and the internal heating roller 340. The control unit 30 controls the halogen heater 350 to adjust the temperature of the internal heating roller 340 based on temperature detection by the temperature sensor 655 serving as a first detection unit. The control unit 30 controls the halogen heater 351 to adjust the temperature of the external heating roller 360 based on temperature detection by the temperature sensor 755 serving as a second detection unit. The temperature sensor 655 is provided close to an outer peripheral surface of the internal heating roller 340 and detects the temperature of the internal heating roller 340. The temperature sensor 755 is provided close to the outer peripheral surface of the external heating roller 360 and detects the temperature of the external heating roller 360. The temperature of the fixing belt 310 is adjusted to the target temperature by temperature adjustment using the internal heating roller 340 and the external heating roller 360.

A contact-separation motor 650, the contact-separation motor 750, a jam detection sensor 800, and a home position sensor 900 are connected to the control unit 30. The contact-separation motor 650 serving as a driving unit (first driving unit) is a motor for moving the belt cleaning unit 700. That is, the control unit 30 controls the contact-separation motor 650 to move the belt cleaning unit 700 between the collection position and the non-collection position. Further, the control unit 30 controls the contact-separation motor 650 to move the web unit 710 between the position where the web 711 comes into contact with the collection roller 720 and the position where the web 711 does not come into contact with the collection roller 720.

The contact-separation motor 750 serving as a second driving unit is a motor for driving the roller cleaning unit 600. The control unit 30 controls the contact-separation motor 750 to swing the holding frame 620, thereby moving the roller cleaning unit 600 between the contact position where the cleaning roller 610 comes into contact with the external heating roller 360 and the separated position where the cleaning roller 610 is separated from the external heating roller 360. The home position sensor 900 is a sensor for detecting that the cleaning roller 610 is at the separated position. The jam detection sensor 800 is a sensor for detecting whether a paper jam has occurred in which the recording material being conveyed is jammed in the middle of a conveyance path during the image forming job. In a case where a jam of the recording material has occurred, the control unit 30 turns off the halogen heaters 350 and 351 to stop heating the fixing belt 310, and stops the drive motors M0 and M1 to stop the fixing belt 310.

### Cleaning Control Processing During Image Formation

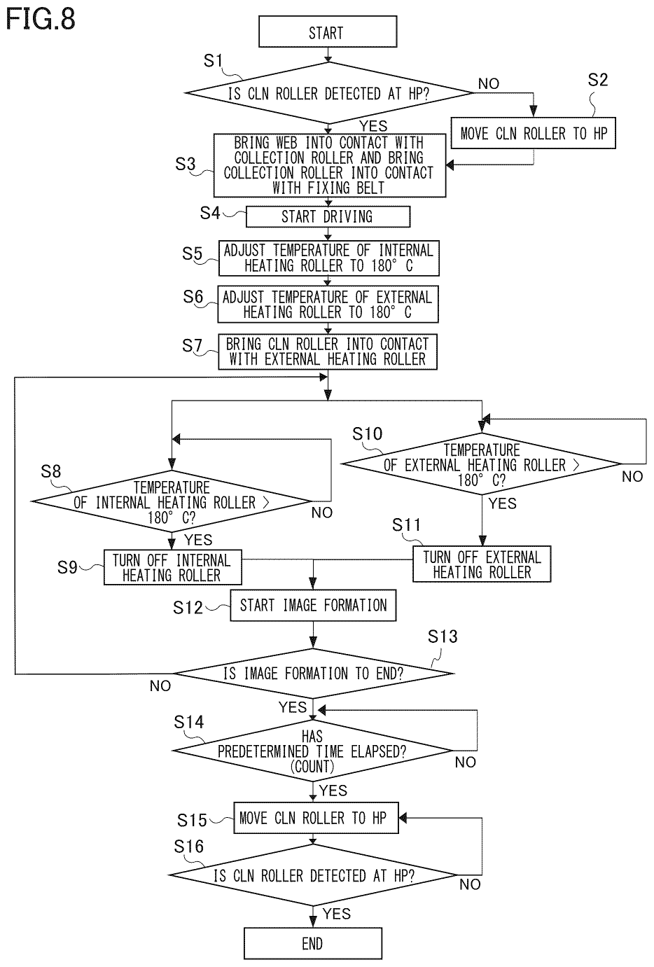

The control unit 30 can execute cleaning control processing (also referred to as a fixing mode) of removing the residual toner from the fixing belt 310 during image formation. Here, the cleaning control processing during the image formation will be described with reference to FIG. 8, as well as FIGS. 2 and 7.

As illustrated in FIG. 8, the control unit 30 determines whether the cleaning roller 610 is at the separated position, where the cleaning roller 610 is separated from the external heating roller 360 based on home position detection of the cleaning roller 610 by the home position sensor 900 (S1). In a case where the cleaning roller 610 is not at the separated position (NO in S1), the control unit 30 controls the contact-separation motor 750 to move the cleaning roller 610 to the separated position (S2). In a case where the cleaning roller 610 is at the separated position (YES in S1) or after the cleaning roller 610 moves to the separated position (S2), the control unit 30 controls the contact-separation motor 650 to bring the web 711 into contact with the collection roller 720, and move the belt cleaning unit 700 to the collection position, to bring the collection roller 720 into contact with the fixing belt 310 (S3).

After bringing the collection roller 720 into contact with the fixing belt 310, the control unit 30 controls the drive motors M0 and M1 to start the rotation of the pressure roller 330 and the internal heating roller 340 such that the fixing belt 310 rotates at, for example, 630 mm/s (sheet passing speed) (S4). The control unit 30 starts heating by the halogen heater 350 and adjusts the temperature of the internal heating roller 340 to a predetermined sheet passing temperature (for example, 180° C.) (S5). In addition, the control unit 30 starts heating by the halogen heater 351 and adjusts the temperature of the external heating roller 360 to a predetermined sheet passing temperature (for example, 180° C.) (S6). That is, when an image is formed on the recording material, a temperature difference between the temperature of the external heating roller 360 and the temperature of the internal heating roller 340 is small. Then, the control unit 30 controls the contact-separation motor 750 to bring the cleaning roller 610 into contact with the external heating roller 360 that rotates following the fixing belt 310 (S7).

The control unit 30 determines whether the temperature of the internal heating roller 340 has reached the sheet passing temperature 180° C. and whether the temperature of the external heating roller 360 has reached the sheet passing temperature 180° C. (S8 and S10). In a case where both the temperature of the internal heating roller 340 and the temperature of the external heating roller 360 have reached the sheet passing temperature 180° C. (YES in both S8 and S10), the control unit 30 turns off the halogen heaters 350 and 351 (S9 and S11). Then, the control unit 30 allows the recording material accommodated in the cassette 9 to pass and starts the image formation on the recording material (S12). When the image formation on the recording material starts in this way, the residual toner may adhere to the fixing belt 310. Thus, the fixing belt 310 can be cleaned by the web 711, and the external heating roller 360 can be cleaned by the cleaning roller 610.

The control unit 30 determines whether to end the image formation (S13). In a case where the control unit 30 determines not to end the image formation (NO in S13), the control unit 30 maintains both the temperature of the internal heating roller 340 and the temperature of the external heating roller 360 at the sheet passing temperature 180° C. and continues the image formation (S8 to S13). In a case where the control unit 30 determines to end the image formation (YES in S13), the control unit 30 determines whether a predetermined time has elapsed from the end of the image formation (S14). The control unit 30 waits until the predetermined time elapses (NO in S14). After the lapse of the predetermined time (YES in S14), the control unit 30 controls the contact-separation motor 750 to separate the cleaning roller 610 from the external heating roller 360 until the cleaning roller 610 is detected by the home position sensor 900 (S15 and S16), and ends the cleaning control processing. It is necessary to rotate the external heating roller 360 at least once in order to remove the residual toner over the entire circumference of the external heating roller 360 after the image formation ends. For example, the predetermined time may be set to 20 seconds to rotate the external heating roller 360 a plurality of times (for example, six times) in order to cause the cleaning roller 610 to more reliably remove the residual toner.

The fixing belt 310 is heated to 180° C. by the internal heating roller 340, and is atmospherically cooled before moving toward the external heating roller 360, and thus, the temperature of the fixing belt 310 is lower than 180° C. when the fixing belt 310 reaches the external heating roller 360. Since the temperature of the external heating roller 360 is adjusted to 180° C., the temperature of the external heating roller 360 is higher than the temperature of the fixing belt 310 at the heating nip portion N2 formed by the fixing belt 310 and the external heating roller 360. However, in the present embodiment, since a distance between the internal heating roller 340 and the external heating roller 360 is not so long, a decrease in temperature when the fixing belt 310 reaches the external heating roller 360 from the internal heating roller 340 is very small. That is, a temperature difference between the external heating roller 360 and the fixing belt 310 at the heating nip portion N2 is very small. In addition, the temperature of the collection roller 720 that comes into contact with the fixing belt 310 and rotates following the fixing belt 310 is slightly lower than the temperature of the fixing belt 310. Thus, during the image formation, the residual toner hardly migrates from the fixing belt 310 having a lower temperature to the external heating roller 360 having a higher temperature, and a large amount of residual toner is removed by the web 711 via the collection roller 720. However, since a small amount of residual toner can adhere to the external heating roller 360 from the fixing belt 310, the residual toner is removed from the external heating roller 360 by the cleaning roller 610.

Meanwhile, in a case where a jam occurs in which the recording material being conveyed is jammed in the middle of the fixing nip portion N1 during the image forming job, a large amount of residual toner may adhere to the fixing belt 310. In such a case, a large amount of residual toner may migrate from the fixing belt 310 to the external heating roller 360, toner saturation occurs in which the toner cannot be completely removed by the cleaning roller 610, and cleaning performance of the cleaning roller 610 deteriorates quickly. Unlike the web 711, the cleaning roller 610 does not supply a new surface free of toner adhesion, and toner saturation occurs as a collection amount of the residual toner increases. In this regard, the residual toner adhering to the external heating roller 360 may be removed by a cleaning unit using a web similar to that of the belt cleaning unit 700 instead of the roller cleaning unit 600. However, it has been difficult to adopt a cleaning unit using a web due to concerns regarding an increase in cost and an increase in size of the image forming apparatus 1.

### Cleaning Control Processing During Jam Processing

In view of the above, in the present embodiment, cleaning performance of the cleaning roller 610 improves during jam processing. Hereinafter, cleaning control processing (also referred to as a cleaning mode) during the jam processing for implementing the above will be described. In a case where a jam occurs during the image forming job, the control unit 30 executes the cleaning control processing (cleaning mode) for removing the residual toner. In the cleaning control processing during the jam processing, when each door is closed after the user removes the recording material jammed in the middle of the conveyance path, it is detected whether or not the recording material remains in the middle of the conveyance path, and if the recording material is not detected, the processing is automatically started. The cleaning control processing may be started in a case where an instruction to start the image forming job is received from the operation unit 4.

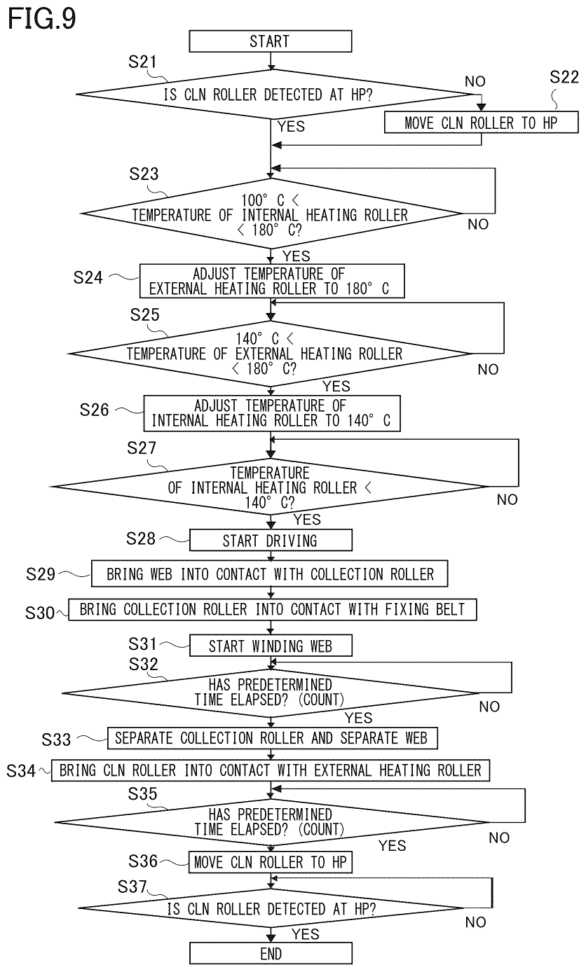

First, the cleaning control processing during the jam processing executed in a case where the recording material is removed in about 5 minutes to 10 minutes after the jam of the recording material is detected will be described with reference to FIG. 9, as well as FIGS. 2 and 7. Description of control similar to the cleaning control processing (see FIG. 8) during the image formation described is not repeated, for conciseness.

As illustrated in FIG. 9, the control unit 30 determines whether the cleaning roller 610 is at the separated position where the cleaning roller 610 is separated from the external heating roller 360 (S21). In a case where the cleaning roller 610 is not at the separated position (NO in S21), the control unit 30 moves the cleaning roller 610 to the separated position (S22). In a case where the cleaning roller 610 is at the separated position, the control unit 30 determines whether the temperature of the internal heating roller 340 is within a predetermined range (for example, 100° C. to 180° C.) (S23). In a case where the temperature of the internal heating roller 340 is within the predetermined range (YES in S23), the control unit 30 starts heating by the halogen heater 351 and adjusts the temperature of the external heating roller 360 to a cleaning temperature (for example, 180° C.) determined to be substantially the same as that during the image formation (S24).

Then, the control unit 30 determines whether the temperature of the external heating roller 360 is within a predetermined range (for example, 140° C. to 180° C.) (S25). In a case where the temperature of the external heating roller 360 is within the predetermined range (YES in S25), the control unit 30 starts heating by the halogen heater 350 and adjusts the temperature of the internal heating roller 340 to a predetermined cleaning temperature (for example, 140° C.) lower than that during the image formation (S26). As a result, the temperature adjustment is performed such that the temperature difference between the temperature of the external heating roller 360 and the temperature of the internal heating roller 340 is larger than that during the image formation. The control unit 30 determines whether the temperature of the internal heating roller 340 has reached the cleaning temperature 140° C. (S27). In this way, the temperature of the fixing belt 310 becomes 140° C., and the temperature of the external heating roller 360 becomes 180° C., which is higher than the temperature of the fixing belt 310 in the vicinity of the heating nip portion N2 between the fixing belt 310 and the external heating roller 360.

In a case where the temperature of the external heating roller 360 has reached the cleaning temperature 180° C. and the temperature of the internal heating roller 340 has reached the cleaning temperature 140° C. (YES in S27), the control unit 30 starts the rotation of the internal heating roller 340 and the pressure roller 330 so as to rotate the fixing belt 310 at, for example, 50 mm/s (cleaning speed) (S28). After the rotation of the fixing belt 310, the control unit 30 brings the web 711 into contact with the collection roller 720 (S29) and moves the belt cleaning unit 700 to the collection position, to bring the collection roller 720 into contact with the fixing belt 310 (S30). In this way, a large amount of residual toner adhering to the fixing belt 310 is removed by the web 711. At this time, in order to supply a new surface free of toner adhesion as described above, the control unit 30 controls a driving unit to wind the web 711 by the winding roller 713 (S31).

The cleaning temperature of the external heating roller 360 may be 160° C. to 200° C., and the cleaning temperature of the internal heating roller 340 may be 120° C. to 160° C. In a case where the cleaning temperature of the internal heating roller 340 is lower than 120° C., the residual toner adhering to the fixing belt 310 is not melted but fixed, and hardly migrates to the collection roller 720. In this case, the fixing belt 310 is not appropriately cleaned by the web 711. On the other hand, in a case where the cleaning temperature of the internal heating roller 340 is higher than 160° C., it becomes difficult to increase the temperature difference between the fixing belt 310 and the external heating roller 360. In a case where the temperature difference between the fixing belt 310 and the external heating roller 360 cannot be increased, the residual toner is likely to migrate from the fixing belt 310 to the external heating roller 360, which is not preferable. The temperature difference between the temperature of the fixing belt 310 and the temperature of the external heating roller 360 may be 10° C. or more.

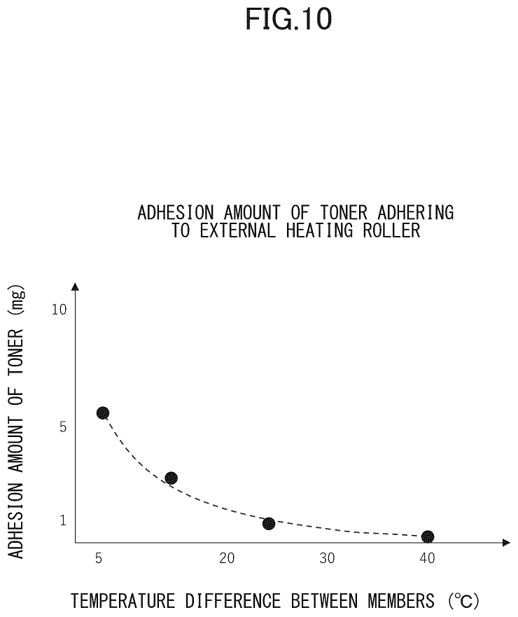

FIG. 10 is a graph illustrating an adhesion amount of toner adhering to a member having a lower temperature according to a temperature difference between members. As described above, the toner is likely to migrate from a member having a higher temperature to a member having a lower temperature. However, as illustrated in FIG. 10, it can be seen that as a temperature difference between the members is larger, the toner is less likely to adhere to the member having a higher temperature (external heating roller), and the adhesion amount of the toner tends to decrease.

Returning to FIG. 9, the control unit 30 determines whether a predetermined time has elapsed since the collection roller 720 was brought into contact with the fixing belt 310 (S32). In order to more reliably remove the residual toner using the web 711 via the collection roller 720, for example, the fixing belt 310 is rotated with the predetermined time set to 10 minutes. The control unit 30 waits until the predetermined time elapses (NO in S32).

In a case where the predetermined time has elapsed (YES in S32), the control unit 30 controls the contact-separation motor 650 to move the belt cleaning unit 700 to the non-collection position, thereby separating the collection roller 720 from the fixing belt 310, and further separating the web 711 from the collection roller 720 (S33). Thereafter, the control unit 30 controls the contact-separation motor 750 to bring the cleaning roller 610 into contact with the external heating roller 360 (S34). The control unit 30 determines whether a predetermined time (for example, 20 seconds) has elapsed since the cleaning roller 610 was brought into contact with the external heating roller 360 (S35). After the lapse of the predetermined time (YES in S35), the control unit 30 controls the contact-separation motor 750 to separate the cleaning roller 610 from the external heating roller 360 until the cleaning roller 610 is detected by the home position sensor 900 (S35 and S36), and ends the cleaning control processing.

During the execution of the fixing mode, as described above, the temperature of the internal heating roller 340 is adjusted to 180° C., and the temperature of the external heating roller 360 is adjusted to 180° C. Thus, in the fixing mode, the temperature difference between the fixing belt 310 and the external heating roller 360 is very small. On the other hand, in the cleaning mode, as described above, the temperature of the internal heating roller 340 is adjusted to 140° C., and the temperature of the external heating roller 360 is adjusted to 180° C. (see S24 and S26).

In this manner, in the cleaning mode, the temperature of the external heating roller 360 can be made higher than the temperature of the fixing belt 310. Further, the temperature difference between the fixing belt 310 and the external heating roller 360 at the heating nip portion N2 can be made larger than that in the fixing mode. By starting the removal of the residual toner adhering to the fixing belt 310 after the temperature difference is made large in this way, the residual toner hardly migrates from the fixing belt 310 to the external heating roller 360, and most of the residual toner is removed by the web 711 via the collection roller 720.

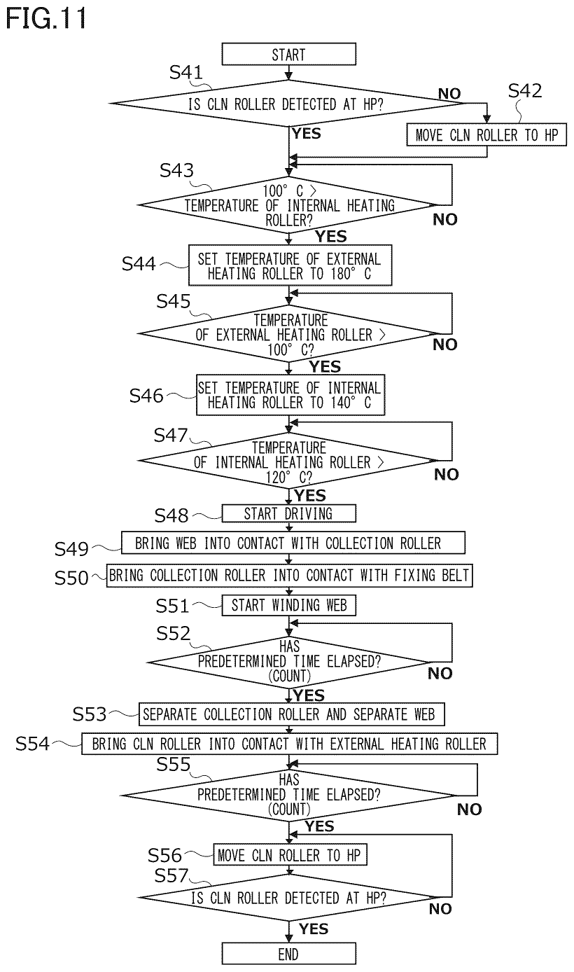

The cleaning control processing during the jam processing executed in a case where the recording material is removed 10 minutes or more after the jam of the recording material is detected will be described with reference to FIG. 11, as well as FIGS. 2 and 7. In this case, since an influence of the room temperature increases with the lapse of time, the temperature of the internal heating roller 340 and the temperature of the external heating roller 360 are lower than those in a case where the recording material is removed in about 5 minutes to 10 minutes, as described above. Depending on the time elapsed to remove the recording material, the temperature of the internal heating roller 340 and the temperature of the external heating roller 360 are lowered to about room temperature. Description of processing similar to the cleaning control processing (see FIG. 9) during the jam processing described above is not repeated, for conciseness.

As illustrated in FIG. 11, the control unit 30 determines whether the cleaning roller 610 is at the separated position (S41). In a case where the cleaning roller 610 is not at the separated position (NO in S41), the control unit 30 moves the cleaning roller 610 to the separated position (S42). In a case where the cleaning roller 610 is at the separated position, the control unit 30 determines whether the temperature of the internal heating roller 340 is lower than a predetermined value (for example, 100° C.) (S43). In a case where the temperature of the internal heating roller 340 is lower than the predetermined value (YES in S43), the control unit 30 starts heating by the halogen heater 351 and adjusts the temperature of the external heating roller 360 to the cleaning temperature (for example, 180° C.) (S44).

Then, the control unit 30 determines whether the temperature of the external heating roller 360 is higher than a predetermined value (100° C.) (S45). In a case where the temperature of the external heating roller 360 is higher than the predetermined value (YES in S45), the control unit 30 starts heating by the halogen heater 350 and adjusts the temperature of the internal heating roller 340 to the cleaning temperature (for example, 140° C.) (S46). The control unit 30 determines whether the temperature of the internal heating roller 340 is higher than a predetermined value (for example, 120° C.) (S47).

In a case where the temperature of the internal heating roller 340 has reached the predetermined value (120° C.) (YES in S47), the control unit 30 rotates the fixing belt 310 at the cleaning speed (S48). Thereafter, in a case where the temperature of the internal heating roller 340 has reached the cleaning temperature (140° C.), the control unit 30 brings the web 711 into contact with the collection roller 720 (S49) and moves the belt cleaning unit 700 to the collection position, to bring the collection roller 720 into contact with the fixing belt 310 (S50). Even in this case, the temperature of the fixing belt 310 becomes 140° C., and the temperature of the external heating roller 360 becomes 180° C. which is higher than the temperature of the fixing belt 310 in the vicinity of the heating nip portion N2 between the fixing belt 310 and the external heating roller 360. In this way, a large amount of residual toner adhering to the fixing belt 310 is removed by the web 711. At this time, the control unit 30 winds the web 711 by the winding roller 713 (S51).

The control unit 30 determines whether a predetermined time (for example, 10 minutes) has elapsed since the collection roller 720 was brought into contact with the fixing belt 310 (S52). In a case where the predetermined time has elapsed (YES in S52), the control unit 30 separates the collection roller 720 from the fixing belt 310, and further separates the web 711 from the collection roller 720 (S53). Thereafter, the control unit 30 brings the cleaning roller 610 into contact with the external heating roller 360 (S54). The control unit 30 determines whether a predetermined time (for example, 20 seconds) has elapsed since the cleaning roller 610 was brought into contact with the external heating roller 360 (S55). After the lapse of the predetermined time (YES in S55), the control unit 30 separates the cleaning roller 610 from the external heating roller 360 (S35 and S36), and ends the cleaning control processing.

In this way, even in a case where the recording material is removed 10 minutes or more after the jam of the recording material is detected, the temperature difference is set to be large, and then the removal of the residual toner adhering to the fixing belt 310 is started as in the cleaning control processing illustrated in FIG. 9. Thus, the residual toner hardly migrates from the fixing belt 310 to the external heating roller 360, and most of the residual toner is removed by the web 711 via the collection roller 720.

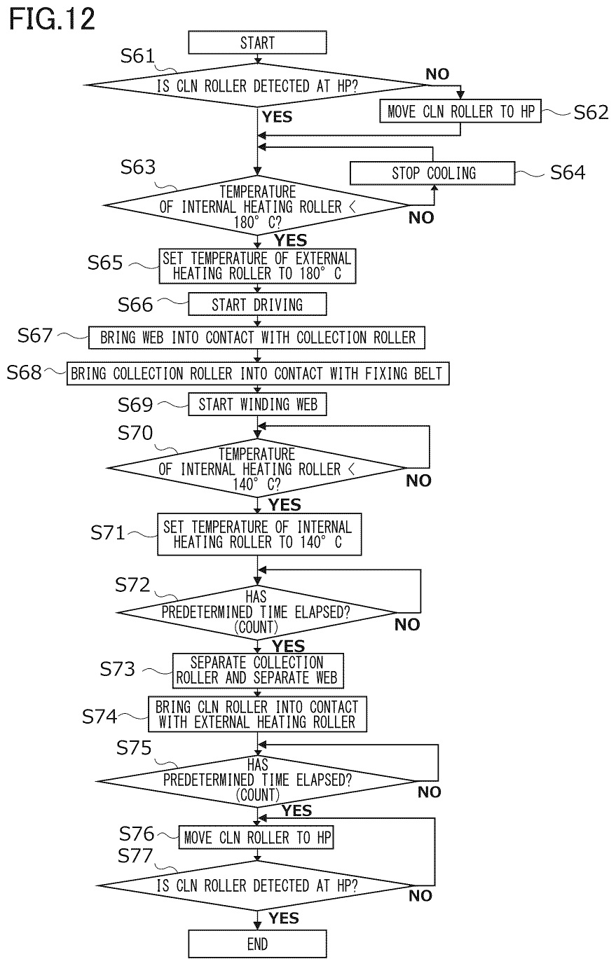

The cleaning control processing during the jam processing executed in a case where the recording material is removed within 5 minutes after the jam of the recording material is detected will be described with reference to FIG. 12, as well as FIGS. 2 and 7. In this case, since the temperature of the internal heating roller 340 and the temperature of the external heating roller 360 are not so much affected by the room temperature, the temperature of the internal heating roller 340 and the temperature of the external heating roller 360 are higher than those in a case where the recording material is removed in about 5 minutes to 10 minutes described above, and are close to those during the image formation. Description of processing similar to the cleaning control processing (see FIG. 11) during the jam processing described above is not repeated, for conciseness.

As illustrated in FIG. 12, the control unit 30 determines whether the cleaning roller 610 is at the separated position (S61). In a case where the cleaning roller 610 is not at the separated position (NO in S61), the control unit 30 moves the cleaning roller 610 to the separated position (S62). In a case where the cleaning roller 610 is at the separated position, the control unit 30 determines whether the temperature of the internal heating roller 340 is lower than a predetermined value (for example, 180° C.) (S63). In a case where the temperature of the internal heating roller 340 is a high temperature equal to or higher than the predetermined value (NO in S63), the control unit 30 waits for a temperature decrease by natural cooling (S64). On the other hand, in a case where the temperature of the internal heating roller 340 is lower than the predetermined value (YES in S63), the control unit 30 starts heating by the halogen heater 351 and adjusts the temperature of the external heating roller 360 to the cleaning temperature (for example, 180° C.) (S65). In this case, the external heating roller 360 is already at a high temperature, and heating of the external heating roller 360 is started in order to maintain the temperature.

Then, the control unit 30 rotates the fixing belt 310 at the cleaning speed (S66). Thereafter, the control unit 30 brings the web 711 into contact with the collection roller 720 (S67) and moves the belt cleaning unit 700 to the collection position, to bring the collection roller 720 into contact with the fixing belt 310 (S68). In this way, a large amount of residual toner adhering to the fixing belt 310 is removed by the web 711. At this time, the control unit 30 winds the web 711 by the winding roller 713 (S69). At this time, the temperature of the external heating roller 360 is higher than the temperature of the fixing belt 310 in the vicinity of the heating nip portion N2 between the fixing belt 310 and the external heating roller 360.

The control unit 30 determines whether the temperature of the internal heating roller 340 has become lower than the cleaning temperature (for example, 140° C.) by natural cooling (S70). In a case where the temperature of the internal heating roller 340 has become lower than the cleaning temperature (YES in S70), the control unit 30 starts heating by the halogen heater 350 and adjusts the temperature of the internal heating roller 340 to the cleaning temperature (S71). That is, the temperature of the fixing belt 310 is adjusted to 140° C., and the temperature of the external heating roller 360 is adjusted to 180° C. which is higher than the temperature of the fixing belt 310 in the vicinity of the heating nip portion N2 between the fixing belt 310 and the external heating roller 360.

As described above, the cleaning temperature of the external heating roller 360 may be 160° C. to 200° C. Although high cleaning performance can be achieved even at the cleaning temperature lower than 160° C., in a case where the cleaning temperature is lower than 160° C., a time elapsed for the temperature of the internal heating roller 240 and the temperature of the external heating roller 360 to decrease to the cleaning temperature by natural cooling becomes long. In a case where the cleaning temperature of the internal heating roller 340 is set to 120° C. to 160° C., and the cleaning temperature of the external heating roller 360 is set to 160° C. or higher, it is easy to increase the temperature difference between the fixing belt 310 and the external heating roller 360. On the other hand, in a case where the cleaning temperature of the external heating roller 360 is set to be higher than 200° C., the residual toner adhering to the fixing belt 310 becomes an over-melted state and has a low viscosity, and it becomes difficult to cause the residual toner to stay on the fixing belt 310. That is, the residual toner easily migrates from the fixing belt 310 to the external heating roller 360. In this case, the fixing belt 310 is not appropriately cleaned by the web 711.

The control unit 30 determines whether a predetermined time (for example, 10 minutes) has elapsed since the collection roller 720 was brought into contact with the fixing belt 310 (S72). In a case where the predetermined time has elapsed (YES in S72), the control unit 30 separates the collection roller 720 from the fixing belt 310, and further separates the web 711 from the collection roller 720 (S73). Thereafter, the control unit 30 brings the cleaning roller 610 into contact with the external heating roller 360 (S74). The control unit 30 determines whether a predetermined time (for example, 20 seconds) has elapsed since the cleaning roller 610 was brought into contact with the external heating roller 360 (S75). After the lapse of the predetermined time (YES in S75), the control unit 30 separates the cleaning roller 610 from the external heating roller 360 (S76 and S77), and ends the cleaning control processing.

Table 1 shows results of an experiment in which a solid image is formed on the fixing belt 310 with the toner and the solid image (toner) is removed from the fixing belt 310. In the experiment, two layers of toner were formed on the fixing belt 310 to form the solid image, and the cleaning control processing (See FIGS. 9, 11, and 12) during the jam processing described above was performed to remove the solid image from the fixing belt 310.

TABLE 1

| | Temperature During Jam Processing | | |
|---|---|---|---|
| | Cold | Mid | Hot |
| Comparative Example | Poor | Fair | Poor |
| Present Embodiment | Good | Good | Good |

“Present Embodiment” in Table 1 indicates a cleaning result in a case where the temperatures of the internal heating roller 340 and the external heating roller 360 were adjusted according to the cleaning control processing (see FIGS. 9, 11, and 12) during the jam processing described above, and the toner was removed from the fixing belt 310. “Comparative Example” in Table 1 indicates a cleaning result in a case where the toner was removed from the fixing belt 310 without adjusting the temperatures of the internal heating roller 340 and the external heating roller 360. In Table 1, “good” indicates that the solid image was almost removed and the cleaning result was acceptable, “fair” indicates that a part of the solid image remained on the fixing belt 310, and “poor” indicates that the solid image was hardly removed and a cleaning failure occurred. The cleaning results were described for “Cold” (low temperature state) indicating a case where the temperature of the internal heating roller 340 at the start of the cleaning control processing of removing the toner is lower than 100° C., “Mid” (medium temperature state) indicating a case where the temperature of the internal heating roller 340 at the start of the cleaning control processing of removing the toner is 100° C. to 180° C., and “Hot” (high temperature state) indicating a case where the temperature of the internal heating roller 340 at the start of the cleaning control processing of removing the toner is higher than 180° C.

As can be understood from Table 1, in the comparative example, the toner was removed while leaving a part of the solid image within 10 minutes in the case of “Mid” (medium temperature state). However, the toner was not removed within 10 minutes, and the cleaning failure occurred in the case of “Cold” (low temperature state) or “Hot” (high temperature state). On the other hand, in the present embodiment, the toner was removed in any temperature state.

As described above, in the present embodiment, the temperatures of the internal heating roller 340 and the external heating roller 360 are adjusted such that the residual toner does not migrate from the fixing belt 310 to the external heating roller 360 during the jam processing. In the cleaning control processing during the jam processing described above, the temperature of the external heating roller 360 is adjusted so as to be substantially the same as that during the image formation for forming an image on the recording material (see S6 in FIG. 8, S24 in FIG. 9, S44 in FIGS. 11, and S65 in FIG. 12). On the other hand, the temperature of the internal heating roller 340 is adjusted to be lower than that during the image formation (see S5 in FIG. 8, S26 in FIG. 9, S46 in FIGS. 11, and S71 in FIG. 12). As the temperature of the internal heating roller 340 is reduced during the image formation, the temperature difference between the temperature of the external heating roller 360 and the temperature of the internal heating roller 340 becomes larger than the temperature difference during the image formation. Then, as the rotation of the fixing belt 310 is started in this state, the residual toner on the fixing belt 310 is removed by the web 711 via the collection roller 720. At this time, since the residual toner migrates from a higher-temperature region to a lower-temperature region, the residual toner hardly migrates to the external heating roller 360 having a higher temperature. Thus, a large amount of residual toner is removed by the web 711. As described above, by rotating the fixing belt 310 after making it difficult for the residual toner to migrate from the fixing belt 310 to the external heating roller 360 during the jam processing, the toner saturation does not occur in the cleaning roller 610, and the deterioration of the cleaning performance of the cleaning roller 610 can be suppressed.

In the above-described embodiment, the intermediate-transfer-type image forming apparatus 1 in which the toner images are primarily transferred from the photosensitive drums 200a to 200d to the intermediate transfer belt 204 and are then secondarily transferred from the intermediate transfer belt 204 to the recording material has been described as an example, but the present technology is not limited thereto. The above-described embodiment may also be applied to a direct-transfer-type image forming apparatus that directly transfers the toner images from the photosensitive drums 200a to 200d to the recording material.

### OTHER EMBODIMENTS

Other embodiment(s) can be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., CPU, micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-034609, filed Mar. 5, 2025, which is hereby incorporated by reference herein in its entirety.

What is claimed is:

1. An image forming apparatus including a fixing device configured to fix a toner image to a recording material, the image forming apparatus comprising:
a belt;
a rotary member configured to pressurize the belt from an outer side of the belt;
a nip portion forming member disposed on an inner side of the belt, configured to sandwich the belt with the rotary member;
an internal heating roller disposed on the inner side of the belt and configured to heat the belt;
an external heating roller in contact with an outer peripheral surface of the belt and configured to heat the belt;
a first detection unit configured to detect a temperature of the internal heating roller;
a second detection unit configured to detect a temperature of the external heating roller;
a first cleaning unit configured to clean the outer peripheral surface of the belt;
a second cleaning unit configured to clean an outer peripheral surface of the external heating roller by a method different from a method used by the first cleaning unit; and
a control unit configured to execute a cleaning mode in which toner adhering to the outer peripheral surface of the belt is removed after a jam of the recording material,
wherein, in the cleaning mode, the control unit is configured to rotate the belt and cause the first cleaning unit to clean the outer peripheral surface of the belt in a state in which the temperature of the external heating roller is higher than the temperature of the internal heating roller.

2. The image forming apparatus according to claim 1, wherein
the belt is configured as an endless, rotatable belt, and
the nip portion forming member is configured to form a nip portion that nips the recording material between the rotary member and the belt.

3. The image forming apparatus according to claim 1, wherein in the cleaning mode, the control unit is configured to adjust the temperature of the external heating roller to be substantially the same as a temperature of the external heating roller during image formation on the recording material and to adjust the temperature of the internal heating roller to be lower than a temperature of the internal heating roller during the image formation.

4. The image forming apparatus according to claim 1, wherein in the cleaning mode, the control unit is configured to rotate the belt and cause the first cleaning unit to clean the outer peripheral surface of the belt in a state in response to a difference between the temperature of the external heating roller and the temperature of the internal heating roller during image formation on the recording material.

5. The image forming apparatus according to claim 1, further comprising a driving unit configured to move the first cleaning unit between a collection position where the first cleaning unit comes into contact with the belt and collects the toner from the belt and a non-collection position where the first cleaning unit is separated from the belt and does not collect the toner from the belt,
wherein the control unit is configured to move the first cleaning unit from the non-collection position to the collection position after rotation of the belt in the cleaning mode.

6. The image forming apparatus according to claim 5, wherein the control unit is configured to return the first cleaning unit from the collection position to the non-collection position after a lapse of a predetermined time after the first cleaning unit moves to the collection position in the cleaning mode.

7. The image forming apparatus according to claim 6, further comprising an other driving unit configured to move the second cleaning unit between a contact position where the second cleaning unit comes into contact with the external heating roller and a separated position where the second cleaning unit is separated from the external heating roller,
wherein the control unit is configured to move the second cleaning unit from the separated position to the contact position after the first cleaning unit is returned to the non-collection position in the cleaning mode.

8. The image forming apparatus according to claim 7, wherein the control unit is configured to return the second cleaning unit to the separated position after a lapse of a predetermined time after the second cleaning unit moves to the contact position in the execution of the cleaning mode.

9. The image forming apparatus according to claim 1, wherein the first cleaning unit includes a collection roller configured to contact with the belt and collect the toner from the outer peripheral surface of the belt, and a web configured to rub the collection roller to clean a surface of the collection roller.

10. The image forming apparatus according to claim 2, wherein the external heating roller is disposed downstream of the internal heating roller and upstream of the nip portion with respect to a rotation direction of the belt so as to push the belt from the outer side toward the inner side.

11. The image forming apparatus according to claim 1, wherein the external heating roller is configured to not sandwich the belt with the internal heating roller.

12. The image forming apparatus according to claim 1, further comprising a heater provided inside the external heating roller and configured to heat the external heating roller.

13. The image forming apparatus according to claim 1, further comprising a web configured to perform the cleaning of the first cleaning unit.

14. An image forming apparatus including a fixing device configured to fix a toner image to a recording material, the image forming apparatus comprising:
a belt;
a rotary member configured to pressurize the belt from an outer side of the belt;
a nip portion forming member disposed on an inner side of the belt, configured to sandwich the belt with the rotary member;
an internal heating roller disposed on the inner side of the belt and configured to heat the belt;
an external heating roller configured to contact with an outer peripheral surface of the belt and heat the belt;
a first detection unit configured to detect a temperature of the internal heating roller;
a second detection unit configured to detect a temperature of the external heating roller;
a first cleaning unit configured to clean the outer peripheral surface of the belt;
a second cleaning unit configured to clean an outer peripheral surface of the external heating roller by a method different from a method used by the first cleaning unit; and
a control unit configured to execute a cleaning mode in which toner adhering to the outer peripheral surface of the belt is removed after a jam of the recording material,
wherein, in the cleaning mode, the control unit is configured to separate the second cleaning unit from the external heating roller, cause the first cleaning unit to clean the outer peripheral surface of the belt in a state in which the temperature of the external heating roller is higher than the temperature of the internal heating roller, and bring the second cleaning unit into contact with the external heating roller.

15. The image forming apparatus according to claim 14, wherein
the belt is configured as an endless, rotatable belt, and
the nip portion forming member is configured to form a nip portion that nips the recording material between the rotary member and the belt.

16. A method for fixing, by a fixing device of an image forming apparatus, a toner image to a recording material, the image forming apparatus including a belt, a rotary member configured to pressurize the belt from an outer side of the belt, a nip portion forming member disposed on an inner side of the belt and configured to sandwich the belt with the rotary member, an internal heating roller disposed on the inner side of the belt and configured to heat the belt, an external heating roller configured to contact with an outer peripheral surface of the belt and heat the belt, a first cleaning unit configured to clean the outer peripheral surface of the belt, and a second cleaning unit configured to clean an outer peripheral surface of the external heating roller by a method different from a method used by the first cleaning unit, the method comprising:
separating the second cleaning unit from the external heating roller;
in a state in which a temperature of the external heating roller is higher than the temperature of the internal heating roller, executing a cleaning mode for cleaning the outer peripheral surface of the belt, and
after a jam of the recording material in the cleaning mode, bringing the second cleaning unit into contact with the external heating roller to remove toner adhering to the outer peripheral surface of the belt.
